(19) United States
(12) Patent Application Publication
(10) Pub. No.: US 2025/0304467 A1
(43) Pub. Date: Oct. 2, 2025

(54) FORMULATIONS FOR TREATING CONTAMINATED SITES WHILE MITIGATING DUST SCATTER

(71) Applicant: Regenesis Bioremediation Products, San Clemente, CA (US)

(72) Inventors: Paul R. Erickson, San Clemente, CA (US); Chase Hartsell, San Clemente, CA (US); Yen-Ling Liu, San Clemente, CA (US)

(21) Appl. No.: 19/232,653

(22) Filed: Jun. 9, 2025

Related U.S. Application Data
(63) Continuation-in-part of application No. 18/953,441, filed on Nov. 20, 2024.
(60) Provisional application No. 63/604,656, filed on Nov. 30, 2023.

(51) Int. Cl. C02F 1/28; B01J 20/20; B01J 20/28; B09C 1/08

(52) U.S. Cl. CPC C02F 1/283; B01J 20/20; B01J 20/28016; B09C 1/08; B09C 2101/00; C02F 2305/04

(57) ABSTRACT

Methods are disclosed for delivering a remedial amendment to a target site. A dedusted agglomerate formulation can be produced by mixing an adsorbent, a surfactant, and a dust control agent. These agglomerates may maintain their agglomerated form when transported to a target site, such as soil or a water treatment site. Once the agglomerates have arrived, they may disintegrate via moisture activation, agitation, or both. When the agglomerates have disintegrated, the amendment may disperse and be delivered to the site, whereafter the amendment can treat any contaminants in the target site. By delivering the amendment in this manner, one can mitigate dust scattering throughout the surrounding environment.

### CROSS-REFERENCE TO RELATED APPLICATIONS

This application is a continuation-in-part of U.S. patent application Ser. No. 18/953,441, filed Nov. 20, 2024 entitled SOIL MIXING PROCESSES FOR STABILIZING CONTAMINATED SOIL WHILE MITIGATING DUST SCATTER, which relates to and claims the benefit of U.S. Provisional Application No. 63/604,656 filed Nov. 30, 2023, and entitled “Soil Mixing Processes for Stabilizing Contaminated Soil”, the entire disclosure of which is hereby wholly incorporated by reference.

### STATEMENT RE: FEDERALLY SPONSORED RESEARCH/DEVELOPMENT

Not applicable.

### BACKGROUND

### 1. Field of Invention

The present application relates to the delivery of an amendment to soil to treat a target site while mitigating dust scatter. More specifically, the present application relates to methods wherein an amendment may be formulated into agglomerates, transported to a target site, and applied to soil. Thereafter, the agglomerates may disintegrate such that the amendment is delivered to the target site while mitigating dust scatter to the surrounding environment.

### 2. Related Art

The production, handling and use of chemicals has inadvertently led to their release and undesirable distribution within the environment. Soil and groundwater are media commonly requiring intervention to remove these unwanted chemicals or mitigate their harmful effects. Currently, several technologies are available to treat soils impacted by chemical contamination, which can include metals, petroleum hydrocarbons, herbicides, pesticides, halogenated hydrocarbons, halogenated dibenzodioxins, polychlorinated biphenyls (PCBs), and per- and polyfluoroalkyl substances (PFAS). For highly stable chemicals, such as PFAS, effective remediation technologies include excavation and disposal, sorption and stabilization, soil washing, thermal/smoldering, and more. Among these treatment technologies, the stabilization of the contaminants in the impacted area by mixing a site-specific mixture of amendments can rapidly reduce the mass of contaminants discharged downstream with relatively low energy and time investment. Compositions and methods related to these techniques are disclosed in U.S. Pat. No. 7,585,132 entitled “METHOD FOR REMEDIATING A CONTAMINATED SITE”, U.S. Pat. No. 9,770,743 entitled “COLLOIDAL AGENTS FOR AQUIFER REMEDIATION”, U.S. Pat. No. 9,776,898 entitled “TREATMENT OF AQUIFER MATRIX BACK DIFFUSION”, U.S. Pat. No. 10,512,957 entitled “COLLOIDAL AGENTS FOR AQUIFER AND METALS REMEDIATION”, U.S. patent application Ser. No. 18/659,147 entitled “TRACER METHODS FOR THE DETERMINATION OF SORBENT CONTENT IN SOILS”, and U.S. patent application Ser. No. 19/186,900 entitled “DRY FORMULATIONS OF MICRON-SCALE ADSORBENTS”, in which the entire disclosures of each are wholly incorporated herein by reference.

The amendments introduced to the soil in such methods typically include various forms of solid adsorbents which can adsorb the contaminants present in soil and substantially, if not entirely, eliminate the ability of those contaminants to further leach from the solid matrix. These amendments can have various particle sizes, ranging from colloidal, fine powders, or more course materials of significantly larger size. Each amendment particle size range has pros and cons associated therewith. Advantageously, colloidal-sized amendments can be thoroughly dispersed in soils, but they usually require liquid handling and delivery. Powdered amendments also allow for good mixing and dispersion, but such amendments can spread throughout the environment as dust. This dust can easily and inadvertently scatter throughout the environment around a target site duc to, for instance, weather effects, handling of the amendment (e.g., opening and moving a bag containing a bulk volume of the amendment can cause dust to fly out), mixing of the amendment in the soil, and handling large amounts of an amendment. Dust scattering in this context may create issues, including inhalation hazards, explosion concerns, and other nuisance issues to neighboring properties and onsite activities. Significant volumes of water are needed to prevent the powdered particles from blowing away and scattering, but even when this precaution is taken, substantial dust scattering may nonetheless occur. Using granular amendments instead can avoid these difficulties, as these amendments are dense enough to where they won't be blown away by wind or mechanical mixing processes, but the coverage of granular amendments can be poor in the same weight percentage as powders and the sorption/immobilization kinetics of these amendments may be suppressed. In addition, the relatively larger particle size can lead to poor utilization of the entire volume of sorbent for immobilization.

To achieve a solution which combines ideal handling and dispersion results, prior attempts have been made to formulate amendments as an agglomerate, which can deliver effective adsorbents to treat contaminants in sediment or wastewater systems by pelletizing sorbents, bentonite clay, and sand. The agglomerated adsorbents can then break down to powdered form after agitation to efficiently adsorb contaminants. However, these prior agglomerates have only proven effective in water-saturated systems, which is not applicable for in-situ soil remediation. Hence, there is a need to improve the mixing processes with alternative materials and techniques.

### BRIEF SUMMARY

To solve these and other problems, methods are contemplated for remediating a target site by formulating an amendment as a water-dispersible agglomerate. An amendment may be agglomerated into serval agglomerates at a location distant from a target site where the amendment will ultimately be delivered. Advantageously, the agglomerates may maintain their agglomerated form when transported and applied upon the soil of the target site. The agglomerate may be capable of disintegrating and releasing the amendment in response to sufficient moisture exposure, sufficient agitation, either, or a sufficient combination of both. By delivering an amendment in this manner, the risk of dust scattering to the surrounding environment may be drastically reduced and thus allow for soils to be treated where such a risk would otherwise discourage or prevent one from treating those soils.

The amendment may include an adsorbent, which may comprise activated carbon, ion exchange resin, clay mineral, modified clay mineral, cyclodextrin polymers, biochar, iron oxides, iron, natural organic matter, or combinations thereof. The amendment may be in a colloidal, powdered, granular, and/or nanoparticle size.

A binder may be included with the amendment when forming an agglomerate. The binder may comprise starch, modified starches, microcrystalline cellulose, gelatin, sucrose, xanthan gum, lignin, lignosulfonate, chitosan, methylcellulose, sodium carboxymethylcellulose, ethylcellulose, clay minerals, or combinations thereof. The binder may help to keep the agglomerate in its agglomerated form prior to initiating the disintegration process.

A disintegrant may also or alternatively be included with the amendment during agglomerate formation. The disintegrant may accelerate the agglomerate disintegration process and react when the agglomerate is exposed to sufficient moisture. The disintegrant may comprise Mucilage of Lepidus sativum, Ispaghula husk/seeds, Hibiscus rosa, xanthan gum, agar and treated agar, guar gum, fenugreek, banana powder, locust bean gum, mango peel pectin, gellan gum, soy polysaccharide, chitin, chitosan, gum Karaya, sodium starch glycolate, crospovidone, croscarmellose sodium, crosslinked alginic acid, ion exchange resins, and combinations thereof.

The process of agglomerating the amendment, optionally with a binder and/or disintegrant, may comprise pin mixing, pan/disc pelletizing, fluidized bed granulation, drum granulation, extrusion or compaction methods, spray drying agglomeration, or combinations thereof. The agglomerates may have a diameter ranging from 0.25 mm to 50 mm. After the agglomerates have been formed, they may be transported to the target site via, for instance, being loaded in a truck, carried on a ship, or both. The agglomerates may travel a distance of at least 1 mile, at least 10 miles, at least 50 miles, at least 100 miles, at least 1,000 miles, or at least 5,000 miles before arriving at the target site.

An alternative type of agglomerate may come in the form of a dedusted agglomerate formulation, which need not necessarily use the abovementioned binders, disintegrants, and agglomeration processes to form a relatively small-sized agglomerate that can mitigate dust scatter when handling the agglomerate. A dedusted agglomerate formulation may be manufactured by providing an adsorbent, a surfactant, and a dust control agent and mixing those components. The moisture content of the resulting dedusted agglomerate may range from 10.0% to 30.0%, preferably 22.0% to 26.0%, which may provide an agglomerate that balances a mitigation of dust scatter while handling the agglomerate while allowing the agglomerate's adsorbent to effectively disperse in soil. The adsorbent may comprise activated carbon (including powdered activated carbon and/or colloidal activated carbon), ion exchange resin, clay mineral, modified clay mineral, cyclodextrin polymers, biochar, iron oxides, iron, natural organic matter, or combinations thereof, and the adsorbent may have a moisture content of 50% or less, preferably 40% or less, even more preferably 30% or less, and most preferably 25% or less by weight of the dry adsorbent. The adsorbent may have a D95 value ranging from 1 to 200 microns in diameter size. The surfactant may comprise anionic surfactants, nonionic surfactants, cationic surfactants, amphoteric surfactants, or combinations thereof, some of which may include sodium lauryl ether sulfate, cocamidopropyl betaine, alpha-olefin sulfonates, sodium dodecyl benzenesulfonate, or combinations thereof. The dust control agent may include lignosulfonate, salts, acrylic polymers, polyvinyl acetate and vinyl acrylic derivatives, molasses-based products, or combinations thereof.

The adsorbent, dust control agent, and surfactant may be mixed with a mixer, including, but not being limited to, rotary drum mixers, ribbon blenders, double cone blenders, and V-blenders. The mixer could come in the form of an augmented variation of any of these types of mixers. The components can be emplaced in the mixer, via gravity feed or a spraying device, for example, in certain combinations, such as with certain components being added to the mixture alone/alongside others and before/after certain other components. Some of a given component may also be added to the mixer at one time while another portion of that component could be added to the mixer at a later time. The adsorbent, dust control agent, and surfactant may be mixed in the mixer for at least five minutes, preferably at least one hour, and most preferably at least two hours.

Dedusted agglomerates can be stored in proper packaging to maintain product specifications without being significantly affected by weathering. The product with proper packaging can similarly be transported to the site via, for instance, being loaded in a truck, carried on a ship, or both. The dedusted agglomerates may travel a distance of at least 1 mile, at least 10 miles, at least 50 miles, at least 100 miles, at least 1,000 miles, or at least 5,000 miles before arriving at the target site.

If sufficient moisture exposure would cause the agglomerates to disintegrate, the moisture required for disintegration can be supplied to the agglomerates from moisture naturally in the soil of the target site. Alternatively, or additionally, the moisture could be supplied to the agglomerates from an external source. The agglomerates may be mixed in the soil via mechanical soil tilling, bucket mixing, auger mixing, or combinations thereof; this mixing may promote disintegration through mixing water with the agglomerates and/or agitating the agglomerates. The mechanism by which agglomerates disintegrate may include swelling, wicking, heat of wetting, a gas-releasing acid-base reaction, deformation recovery, enzymatic reaction, particle repulsive force initiated by water exposure, or combinations thereof.

A homogenizer indicator may be included in the amendment to indicate when the amendment has been homogeneously distributed in a target site. In particular, a homogenizer indicator of colloidal activated carbon may provide a visually conspicuous indication that the amendment has been adequately distributed. One may mix the amendment in the soil of a target site until a homogeneous distribution is achieved, as may be indicated by a homogenous coloration of the soil when colloidal activated carbon is present.

The target site may include contaminants, in which case the amendment and any adsorbents thereof may be suited to treat those contaminants via adsorption. The contaminants may comprise of metals, petroleum hydrocarbons, herbicides, pesticides, halogenated hydrocarbons, halogenated dibenzodioxins, polychlorinated biphenyls (PCBs), per- and polyfluoroalkyl substances (PFAS), or combinations thereof.

In alternative to treating contaminated soils, the agglomerates of this disclosure can be used to treat contaminants associated with other applications, like sediment remediation, drinking water treatment, wastewater treatment, stormwater management, and construction dewatering. Additional types of contaminants that can be treated include tire-derived chemicals, contaminants from pharmaceuticals and personal care products (PPCPs), taste and odor compounds, cyanotoxins, or combinations thereof.

All of these embodiments are contemplated to be within the scope of this disclosure. These and other embodiments will become readily apparent to those skilled in the art from the following detailed description of the preferred embodiments, the disclosure not being limited to any particular preferred embodiment.

### BRIEF DESCRIPTION OF THE DRAWINGS

These and other features and advantages of the various embodiments disclosed herein will be better understood with respect to the following description and drawings, in which:

FIG. 1 shows the results of an experiment comparing the visualization of colloidal activated carbon and powdered activated carbon.

### DETAILED DESCRIPTION

Disclosed herein are methods of delivering amendments to a target site by formulating those amendments as water-dispersible agglomerates. By agglomerating an amendment having nanoparticle, colloidal, powdered, and/or granular adsorbents with a binder and a water-activated disintegrant, an agglomerate may be formed which can remain intact while transporting from where the agglomerate was formed to a target site where the amendment will ultimately be delivered. The agglomerates may be capable of disintegrating when sufficiently agitated and/or exposed to sufficient moisture, which could be supplied from the moisture in the soil the agglomerate is applied to and/or from an external source of water. By delivering an amendment in this manner, a target site can be treated effectively while greatly reducing the risk of dust scattering throughout the surrounding environment.

This description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as primary and secondary and the like are used solely to distinguish one from another entity without necessarily requiring or implying any actual such relationship or order between such entities.

At the outset, an amendment may be selected which may be suited to treat a particular target site. Such an amendment may have absorbents, which can include, but are not limited to, activated carbon, ion exchange resin, clay mineral, modified clay mineral, cyclodextrin polymers, biochar, iron oxides, iron, natural organic matter, or combinations thereof. These adsorbents may be in granular, powdered, colloidal, and/or nanoparticle form.

The adsorbent(s) selected may depend on the context the amendment is to be used. For example, if the amendment is to be deployed at a target site having certain soil properties and/or a particular type or concentration of contaminants present or anticipated to be present in the future, the adsorbents may be chosen to achieve ideal distribution in that site and/or effectively treat those contaminants. The decision as to which amendment to deploy for the target site may be based on information from literature, extraction and experimentation upon the soil and/or contaminants from the soil, general knowledge of those skilled in the art, etc. The contaminants which may be targeted by these amendments may include, but are not limited to, metals, petroleum hydrocarbons, herbicides, pesticides, halogenated hydrocarbons, halogenated dibenzodioxins, polychlorinated biphenyls (PCBs), per- and polyfluoroalkyl substances (PFAS), and combinations thereof. If necessary, a step may be taken to acquire or manufacture an appropriate absorbent material. Some adsorbents may be commercially available and ready to be agglomerated, while others may need to be sized down to a preferred powdered or colloidal size via pulverization, wet milling, or other appropriate size reduction methods.

The amendment may come in the form of a dry formulation of a micron-scale adsorbent. In this respect, the adsorbent formulations disclosed Applicant's previously filed U.S. patent application Ser. No. 19/186,900, entitled “DRY FORMULATIONS OF MICRON-SCALE ADSORBENTS,” the entire disclosure of which is incorporated by reference herein in its entirety, may be used in the agglomerates of this present disclosure. This includes dry formulations of micron-scale adsorbents having a moisture content of 50% or less, preferably 40% or less, even more preferably 30% or less, and most preferably 25% or less by weight of the dry formulation.

It is contemplated that the agglomerates and amendments discussed herein need not be limited to in-situ soil remediation applications and may be suited for deployment at other types of sites which are or could later be impacted by various types of contaminants. For example, the site could be a wastewater treatment site, a site associated with stormwater management, a site associated with construction dewatering, a site associated with sediment remediation, a drinking water treatment site, or a site which is anticipated to be impacted in the future such that the adsorbent is delivered to the site as a proactive measure. Contaminants which could be treated at these sites with the agglomerates and adsorbents discussed herein include, in addition to those already listed above, tire-derived chemicals like 6PPD-Q, pharmaceutical-based contaminants such as sulfonamide antibiotics, steroid hormones, and quinolones, contaminants originating from personal care products, such as triclosan, taste and odor compounds like 2-methylisoborncol and gcosmin, cyanotoxins such as microcystins, nodularins, and anatoxin-a, and combinations thereof.

To help form agglomerates of the chosen adsorbent, a binder may also be chosen. Examples of binders suitable for this purpose include, but are not limited to, starch, modified starches, microcrystalline cellulose, gelatin, sucrose, xanthan gum, lignin, lignosulfonate, chitosan, methylcellulose, sodium carboxymethylcellulose, ethylcellulose, clay minerals, and combinations thereof. The binding strength provided by the binder may be a critical property in maintaining and disintegrating the agglomerate, as will be discussed momentarily with respect to agglomerate formation. Ideal binders may not only provide enough binding strength to form the agglomerate but also have little adverse impact on the adsorbent's performance when delivered in the soil. In particular, preferred binders would not inhibit the sorption affinity and capacity of the adsorbents nor cause substantial flocculation of the adsorbents which prevents adequate disintegration. Additionally, binders which can form an effective agglomerate while making up a lower weight percentage of that agglomerate are preferred, since that would allow for a higher concentration of adsorbents to be delivered to target site per agglomerate. It is further contemplated that some binders may provide additional advantages to soil stabilization compared to others, such as reducing the time needed for an agglomerate to disintegrate or enhancing contaminant immobilization.

Disintegrants, particularly super disintegrants (or sometimes referred to as superdisintegrants), may also be included to promote disintegration of the agglomerate when applied to the soil at a target site. Preferably, these disintegrants will only promote disintegration of the agglomerate when exposed to sufficient amounts of water. Suitable disintegrants for such a purpose include Mucilage of Lepidus sativum, Ispaghula husk/seeds, Hibiscus rosa, xanthan gum, agar and treated agar, guar gum, fenugreek, banana powder, locust bean gum, mango peel pectin, gellan gum, soy polysaccharide, chitin, chitosan, gum Karaya, sodium starch glycolate, crospovidone, croscarmellose sodium, crosslinked alginic acid, ion exchange resins, and combinations thereof. Such disintegrants may be required to accelerate the disintegration process to achieve a practically efficient and effective release of the amendment into the soil.

It is contemplated that an agglomerate, potentially with the aid of moisture-activated disintegrants, may disintegrate and release their amendments via numerous potential mechanisms, which will be described in this paragraph. However, it will be noted that there could be additional/alternative mechanisms in which an agglomerate may disintegrate with or without the aid of a disintegrant; in this respect, unknown or future developed disintegrants which can lead to similar disintegration results may be suitably used in the methods disclosed herein. Swelling, whereby the agglomerate swells upon moisture contact and thus allows more water to penetrate and accelerate disintegration, is a particularly effective mechanism. Another effective mechanism is wicking, where water can penetrate a porous agglomerate via capillary action, causing bonds to weaken. For a heat of wetting mechanism, if an exothermic disintegrant is present in an agglomerate, wetting the agglomerate can generate localized stress and break down the agglomerates. If such a reaction exists between a disintegrant and water, a disintegrant may take part in a gas-releasing acid-base reaction to promote disintegration. If a disintegrant is distorted during compression into an agglomerate, it may return to its original structure when the agglomerate is wetted; by expanding is this deformation recovery mechanism, the disintegrants may boost the rate at which the agglomerates disintegrate. If the disintegrants include enzymes, they may reduce the binding forces holding the adsorbent material together in an agglomerate to promote disintegration. Particle repulsive forces can arise when certain disintegrants encounter water, causing the adsorbent material to break apart from the agglomerate.

Once the amendments, binders, and disintegrants have been chosen, an agglomeration process may be performed to form agglomerates. Suitable agglomeration processes include, but are not limited to, pin mixing, pan/disc pelletizing, fluidized bed granulation, drum granulation, extrusion or compaction methods, spray drying agglomeration, and combinations thereof. The suitability of an agglomeration technique, and thus the decision to employ such a technique, may be based on the desired characteristics of the agglomerates to be produced. In particular, ideal agglomerates would remain in the agglomerated form during shipping and handling but disintegrate when desired under the specified moisture and/or agitation conditions. Multiple agglomeration processes can be used, and a particular agglomeration process can be carried out multiple times when forming agglomerated amendments. It can be seen that the properties of agglomerates may vary depending on the chosen amendment, adsorbents, binders, disintegrants, and agglomeration processes, as well as the soil in which the amendment will be deployed upon. Therefore, one may experiment with various combinations and test those combinations on soil samples to determine which combination provides the best balance of agglomerate formation/stabilization and case of disintegration when desired.

The adsorbents may be present in the agglomerates formed at any value from 1%-99%, preferably 50-99%, by weight of an agglomerate. It is contemplated that lower or higher concentrations of adsorbents in an agglomerate may be more suited for particular impacted soil zones/contaminants, as this concentration could determine how aqueous or solid the adsorbent medium is respectively. Binders may be present in a concentration ranging from 0.1-25% by weight of an agglomerate. The disintegrants may be present in a concentration ranging from 0.01-20% by weight of an agglomerate. Multiple, individual agglomerates may be formed during an agglomeration process. The agglomerates formed may have a diameter size ranging from 0.25 mm to 50 mm.

Agglomerates may alternatively come in the form of a dedusted agglomerate formulation. These agglomerates may be relatively small compared to the types of agglomerates described above and may be made by mixing adsorbents with water and certain surfactants; in particular, these agglomerates may have a D95 value ranging from 1 to 200 microns, meaning that 95% of the agglomerates (by weight and/or volume) have a size at or lower than the D95 value. These agglomerates can thus be considered dedusted in the sense that the adsorbents therein are not as prone to scattering throughout the environment, despite the relatively small size of these agglomerates. While this class of dedusted agglomerates may be formed without using the aforementioned binders, disintegrants, and agglomeration techniques, such components and techniques are not necessarily excluded from the scope of the composition and formation of these dedusted agglomerate formulations.

The process of forming a dedusted agglomerate can include a step of selected an amendment, like activated carbon, ion exchange resin, clay mineral, modified clay mineral, cyclodextrin polymers, biochar, iron oxides, iron, natural organic matter, or combinations thereof, suitable for treating a site. These adsorbents may be in granular, powdered, colloidal, and/or nanoparticle form. Collectively, the adsorbents present in a dedusted agglomerate can have a D95 size value ranging from 1 to 200 microns, meaning that 95% of the adsorbent particles (by weight and/or volume) have a particle size at or lower than the D95 value. Ideally, the adsorbents of a dedusted agglomerate would include both powdered activated carbon and colloidal activated carbon.

Additionally, one or more surfactants may be chosen for forming the dedusted agglomerate. The surfactant may include anionic surfactants, nonionic surfactants, cationic surfactants, amphoteric surfactants, or combinations thereof. Specific examples of such surfactants include, but are not limited to, sodium lauryl ether sulfate, cocamidopropyl betaine, alpha-olefin sulfonates, and sodium dodecyl benzenesulfonate. A preferred embodiment uses only cocamidopropyl betaine as the surfactant.

A dust control agent may also be selected. The dust control agent may include lignosulfonate, salts, acrylic polymers, polyvinyl acetate and vinyl acrylic derivatives, molasses-based products, or combinations thereof.

To agglomerate an amendment into a dedusted agglomerate, a mixer may be used, such as a mixer that uses a tumble blending method. Types of suitable mixers include, but are not limited to, rotary drum mixers, ribbon blenders, double cone blenders, and V-blenders. The mixer may be cleaned before use, such as with vacuums and/or a water/soap solution, which may allow the same mixer to be used multiple times to manufacture multiple batches of dedusted agglomerates. The individual components of the adsorbent, dust control agent, surfactant, and water may be emplaced in a mixing chamber of the mixer in any order and combination (e.g., certain components can be emplaced in the mixing chamber at the same time or at different times). Emplacement methods include gravity feed of one or more components into a mixing chamber and spraying one or more components into the mixing chamber. The components may be mixed for at least five minutes, preferably at least an hour, or most preferably, at least two hours. The final dedusted agglomerate product can be discharged from the mixer and placed into a container, such as a sack, for storage and/or transportation.

Table 1 below provides five compositions which were individually mixed in an experiment to form a control mixture and four sample dedusted agglomerate formulations. The concentrations of the components are expressed as weight percentages. Sample 4 corresponds to a preferred composition using cocamidopropyl betaine as the only surfactant.

| Component | Control | Sample 1 | Sample 2 | Sample 3 | Sample 4 |
|---|---|---|---|---|---|
| Water | 7.4% | 13.8% | 9.7% | 6.6% | 9.7% |
| 40% sodium | 0.0% | 9.2% | 9.7% | 0.0% | 0.0% |
| dodecyl | | | | | |
| benzenesulfonate | | | | | |
| 30% sodium | 0.0% | 0.0% | 0.0% | 11.5% | 0.0.% |
| lauryl ether | | | | | |
| sulfate | | | | | |
| 40% | 0.0% | 0.0% | 0.0% | 0.0% | 9.7% |
| cocamidopropyl | | | | | |
| betaine | | | | | |
| Powdered | 86.1% | 71.5% | 75.0% | 76.2% | 75.0% |
| Activated | | | | | |
| Carbon | | | | | |
| Colloidal | 3.7% | 3.1% | 3.2% | 3.3% | 3.2% |
| Activated | | | | | |
| Carbon | | | | | |
| Sodium | 2.8% | 2.3% | 2.4% | 2.5% | 2.4% |
| Lignosulfonate | | | | | |

Table 2 below lists a various physical testing results of the compositions from Table 1 after mixing those individual compositions. Ideal mixed compositions were found to have a moisture content ranging from 10.0% to 30.0%, more ideally 22.0% to 26.0%; these ranges strikes a good balance between reducing dust scatter-susceptibility of the formulation (as dust scatter is less prone to occur at higher moisture content levels) while achieving effective dispersion of the adsorbents in water (which occurs more readily at lower moisture content levels). The pouring angles were measured by affixing a protractor to a stable stand inside a low airflow chamber, providing a 50-gram sample of the mixed composition, and measuring the angles in which the sample approximately began to pour and when 95% or more of the composition has poured, with the latter measurement being averaged across several trials. The angle of repose was measured by providing a 50-gram sample of the composition and pouring the sample through a funnel and onto the middle of a target; the angle of repose was calculated with the equation Tan ⊖=[Height of the sample from the center of the target]/[Radius of the sample from the center of the target].

| | Control | Sample 1 | Sample 2 | Sample 3 | Sample 4 |
|---|---|---|---|---|---|
| Visual Note | Dusty, | agglomeration | Slightly | Slightly | Agglomeration |
| | consistent | | dusty, | dusty, | |
| | | | consistent | consistent | |
| Moisture | 12.03% | 25.50% | 21.94% | 21.58% | 21.63% |
| Content | | | | | |
| Pour Angle | 25.57 | 25.71 | 31.71 | 35.71 | 29.29 |
| Average | | | | | |
| Approximate | 10.00 | 15.00 | 25.00 | 15.00 | 20.00 |
| Pour Angle | | | | | |
| Start | | | | | |
| Angle of | 4.32 | 23.07 | 17.66 | 8.66 | 18.03 |
| Repose | | | | | |

An exemplary working embodiment has been successfully used to manufacture agglomerates from the composition described in Sample 4 in the tables above. This working embodiment used a Rollo-Mixer® sold by Continental Products Corporation from Osseo, Wisconsin. Powdered activated carbon, colloidal activated carbon, sodium lignosulfonate, and cocamidopropyl betaine and water, were introduced into the mixer and mixed for two hours, after which the mixture was discharged and deposited into a sack from the mixer's discharge hopper.

Once the agglomerates have been formed, they may be packaged and stored properly prior to use. Beneficially, the agglomerates may remain in their specific specifications while stored and kept away from moisture adequate to disintegrate them. Whenever the agglomerates are ready for use, they may be transported from where the agglomerates were formed/stored to the target site to be treated. In this respect, the agglomerate may be transported a distance of at least 1 mile, at least 10 miles, at least 50 miles, at least 100 miles, at least 1,000 miles, or at least 5,000 miles. When transported over a certain distance, the agglomerate may remain intact to an extent that would prevent substantial dust generation. In this respect, at least 80% of the amendment can remain in an agglomerated form when transported over this distance. Vehicles like trucks and ships can be used to transport the agglomerate to the target site over land, sea, or both.

When the agglomerates have arrived at the target site, the agglomerate may be applied to the soil to be treated. While a target site may be one which already has certain contaminants present, it is also contemplated that the target site may be one which is not contaminated at the time the agglomerate is applied; in such a case, the delivery of an adsorbent on that site may serve as a proactive treatment in the event that the target site does become contaminated or is expected to become contaminated in the future. The total amount of amendments delivered to a target site can be described as a weight percentage of the soils, such as in the range 0.5-20% w/w. The appropriate dose may be determined based on the contaminant concentrations, soil properties, a target cleanup criteria (which could be based on a governmental guideline), performing bench-scale tests to quantify the reduction in contaminant leaching after addition of the amendments at various loadings, and combinations thereof. Once the target dose of the appropriate sorbent is determined, one can extrapolate the proper amount of agglomerates needed and transport that amount to the target site.

The agglomerate may readily disintegrate, and thus release the amendments into the soil, in response to sufficient moisture, sufficient agitation, or both. With respect to disintegration by moisture, the moisture content present in the soil may be sufficient to disintegrate the agglomerate. If needed or desired, an external source of water, such as from a local fire hydrant or water transported to the site, may be supplied with a hose to provide moisture sufficient to disintegrate the agglomerates. Preferably, the water supplied from an external source in this manner would not create mud, or at least keep mud generation low, in the target site. The force/moisture required to disintegrate the agglomerates may depend on the combination of adsorbents, binders, disintegrants, and agglomeration processes used to form the agglomerates.

With the agglomerates applied on the soil, the soil may be mixed to promote disintegration of the agglomerates via agitating the agglomerates, mixing water with the agglomerates, or both mechanisms of disintegration. Usable soil mixing techniques include conventional soil treatment methods, like mechanical soil tilling, bucket mixing, auger mixing, the employing specialty soil mixing tools, and combinations thereof.

It can be appreciated that by deploying agglomerates and causing them to disintegrate them upon and within the soil, an amendment and its adsorbents may be delivered and dispersed in a target site while considerably mitigating the risk of dust spreading and scattering into the surrounding environment. Thus, a site may be more readily and extensively treated when such a risk would limit or prevent one from treating that site with an otherwise appropriate amendment.

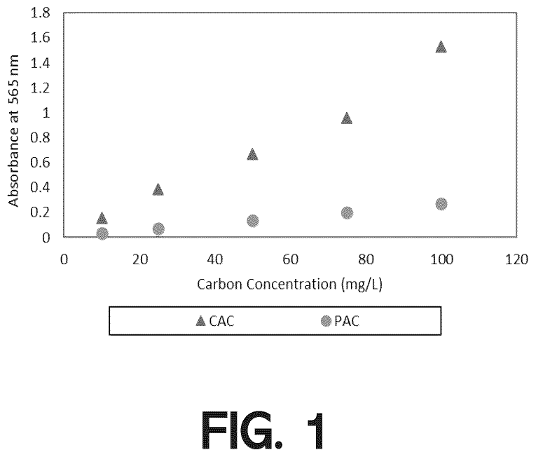

It may be desirable to ensure the amendment is homogeneously mixed in the soil, as this can ensure that any contaminants in the target site become effectively immobilized. However, the components of an amendment may not be visually conspicuous in the soil to a degree which would allow one to visually inspect the soil and discern when the amendment has been homogenously mixed. This may particularly be the case when using a low concentration of amendments relative to the soil mass, as may be the case when treating mildly contaminated sites. While it is common to use a filler (i.e., some inactive ingredient), it would be far more efficient for one of the active species in an amendment to serve this purpose. In particular, colloidal activated carbon (CAC) has been found to be very effective as a homogenizing indicator, due to its dark, discernable color as well as its size, which can coat the soil particle better than powdered activated carbon (PAC). For conventional powdered activated carbon, visual confirmation of distribution becomes a challenge below 0.5% w/w by weight percentage of the soils. As experimentally demonstrated by the difference in optical density between colloidal activated carbon and powdered activated carbon (as discussed in relation to FIG. 1 below), a color change by addition of colloidal activated carbon is noticeable at nearly one tenth of the dose of powdered activated carbon. Therefore, if a target site does not require a large concentration of amendment to treat, such as in the concentration range of 0.1-2% w/w by weight percentage of the soils, colloidal activated carbon can be included in the amendment such that it can serve as a visual indicator that the amendment has been homogeneously mixed in the soil. One can determine that soil is homogenously mixed with colloidal carbon in a manner not possible with powdered activated carbon, and stop mixing that area of a target site, once they observe that the soil turned to a homogenous, dark color. Thus, when mixing an amendment in the soil, the soil may be continually mixed until the soil visually appears to be of a homogeneous coloration.

Referring now to FIG. 1, the results of an experiment comparing the visualization of colloidal activated carbon and powdered activated carbon are shown. A series of solutions with varying carbon concentrations was prepared using either colloidal activated carbon or powdered activated carbon. No dispersants or additional chemicals were included that could interfere with the measurements. The solutions were made in deionized water, containing carbon concentrations of 10, 25, 50, 75, and 100 mg/L. The carbon solutions were placed in a cuvette immediately after being shaken vigorously to measure their ultraviolet absorbance at a wavelength of 565 nm using ultraviolet-visible spectroscopy. The higher absorbance of CAC indicates that it has a better visual impact than PAC at the same weight.

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter and is not intended to serve as limitations of alternative devices and methods within the spirit and scope of this disclosure.

What is claimed is:

1. A method of manufacturing a dedusted agglomerate, the method comprising the steps of:
providing an adsorbent;
providing a surfactant, the surfactant comprising anionic surfactants, nonionic surfactants, cationic surfactants, amphoteric surfactants, or combinations thereof;
providing a dust control agent; and
mixing the adsorbent, surfactant, and dust control agent.

2. The dedusted agglomerate of claim 1.

3. The dedusted agglomerate of claim 2, wherein the dedusted agglomerate has a moisture content ranging from 10.0% to 30.0%.

4. The method of claim 1, wherein the adsorbent has a D95 value ranging from 1 to 200 microns in diameter size.

5. The method of claim 1, wherein the adsorbent comprises: activated carbon, ion exchange resin, clay mineral, modified clay mineral, cyclodextrin polymers, biochar, iron oxides, iron, natural organic matter, or combinations thereof.

6. The method of claim 5, wherein the activated carbon comprises powdered activated carbon and colloidal activated carbon.

7. The method of claim 1, wherein the adsorbent has a moisture content of 50% or less.

8. The method of claim 1, wherein the dust control agent comprises sodium lignosulfonate.

9. The method of claim 1, wherein said step of mixing comprises mixing the adsorbent, surfactant, and dust control agent in a mixer, the mixer being selected from: a rotary drum mixer, a ribbon blender, a double cone blender, or a V-blender.

10. The method of claim 1, wherein the adsorbent, surfactant, and dust control agent are mixed for at least five minutes during said step of mixing.

11. The method of claim 1, wherein the surfactant comprises sodium lauryl ether sulfate, cocamidopropyl betaine, alpha-olefin sulfonates, sodium dodecyl benzenesulfonate, or combinations thereof.

12. A method of treating a site, the method comprising the steps of:
providing an adsorbent;
providing a surfactant, the surfactant comprising anionic surfactants, nonionic surfactants, cationic surfactants, amphoteric surfactants, or combinations thereof;
providing a dust control agent;
mixing the adsorbent, surfactant, and dust control agent to form a dedusted agglomerate;
disintegrating the dedusted agglomerate via supplying moisture to the dedusted agglomerate, agitating the dedusted agglomerate, or both;
wherein said disintegrating causes the adsorbent to be delivered to the site.

13. The method of claim 12, wherein the method further comprises a step of:
transporting the dedusted agglomerate to the site;
wherein the dedusted agglomerate travels a distance of at least one mile during said step of transporting.

14. The method of claim 12, wherein the site is soil containing a contaminant or a water treatment site containing the contaminant.

15. The method of claim 14, wherein the contaminant comprises metals, petroleum hydrocarbons, herbicides, pesticides, halogenated hydrocarbons, halogenated dibenzodioxins, polychlorinated biphenyls (PCBs), per- and polyfluoroalkyl substances (PFAS), tire-derived chemicals, contaminants from pharmaceuticals and personal care products (PPCPs), taste and odor compounds, cyanotoxins, or combinations thereof.

16. The method of claim 12, wherein the surfactant comprises sodium lauryl ether sulfate, cocamidopropyl betaine, alpha-olefin sulfonates, sodium dodecyl benzenesulfonate, or combinations thereof.
